(19) United States
(12) Patent Application Publication
(10) Pub. No.: US 2008/0298606 A1
(43) Pub. Date: Dec. 4, 2008

(54) WIRELESS DIGITAL AUDIO PLAYER

(75) Inventors: Kevin M. JOHNSON, Natick, MA (US); John D. GUNDLACH, Acton, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: MANIFOLD PRODUCTS, LLC, Natick, MA (US)

(21) Appl. No.: 12/131,603

(22) Filed: Jun. 2, 2008

Related U.S. Application Data
(60) Provisional application No. 60/941,559, filed on Jun. 1, 2007.

(51) Int. Cl. H04R 1/10

(52) U.S. Cl. 381/74

(57) ABSTRACT

The present disclosure relates to a device and method for audio playback, comprising at least two earpieces wherein each of the earpieces include memory configured to store audio content and/or data thereon and a timing device. The two earpieces are configured to asynchronously provide audio playback of the audio content stored in said memory upon or after synchronization and at a rate determined by the timing device to provide acceptably matched audio content.

### CROSS-REFERENCE TO RELATED APPLICATIONS

The present application claims the benefit of the filing date of U.S. Provisional Application No. 60/941,559, filed on Jun. 1, 2007, the teachings of which are incorporated herein by reference.

### FIELD OF INVENTION

The present invention relates to a wireless digital audio player for a user's ear (e.g. in-ear or on-ear) using independent, asynchronous generators playing in unison which may optimize weight and playback time of audio data.

### BACKGROUND

Digital music players allow a listener to enjoy high-quality sound from a relatively compact device, which may be capable of holding anywhere from a few hundred to 15,000 songs. The audio may be digitally encoded into files using a variety of techniques. One of the more common current encoding formats for the audio files is defined in the Moving Picture Experts Group's MPEG-1 layer 3 audio standard (commonly called MP3). However, a number of other formats may also be utilized, such as WAV, WMA, AAC, Apple Lossless, AIFF, etc.

Major categories of digital music players may include flash memory-based players and hard disk players; however, a number of other digital music players or portable music players are also available. One of the first devices to arrive on the market was based on flash memory. Flash memory is typically considered to be non-volatile, meaning it can retain information without electricity, but is electronically erasable and reprogrammable. Flash based players offered a relatively small amount of storage, usually between 32 and 128 MB. As the price for this memory has decreased, the amount of storage in these devices has increased to 512 MB or more. After being digitally compressed, each song may require about 1 MB per minute using the MP3 format, giving the listener from 30 minutes to eight hours of listening time. Because the technology may be based on electrically programmable circuits, there may not be any moving parts.

Additionally, the circuits of flash memory players may require relatively little physical space, allowing the players to be very small. These two factors may make the flash players relatively ideal for running, working out or other activities where CDs might skip or other music devices may otherwise be too bulky. There are a number of flash memory-based players being offered from companies like iRiver, Rio, Creative and Sony and Apple.

Even though digital audio players (DAPs) have gotten smaller with time, the current state of the art digital audio player may be relatively large and, for example, must be strapped to your body, such as on the arm or waist while exercising. Furthermore, in most cases a cable may be required to deliver the sound to the ear. All this can be cumbersome and may interfere with a running and/or gym workout routine. In addition, wireless players are available which require a separate player with a transceiver. However, transmission of streaming audio remains energy intensive for such transceiver based wireless technology, thereby leading to battery size requirements and corresponding weight issues making an in ear or on ear device, based upon such approach, inconvenient and one that is not optimized for users desiring the ability to exercise and remain relatively mobile.

### SUMMARY

In a first exemplary embodiment, the present disclosure relates to a device for audio playback, comprising at least two earpieces wherein each of the earpieces include memory configured to store audio content and/or data thereon. The earpieces include a timing device and are configured to asynchronously provide audio playback of audio data stored in the memory upon or after synchronization and at a rate determined by the timing device to provide an acceptably matched audio content.

In a second exemplary embodiment, the present disclosure relates to a method of playing audio playback to a user by providing at least two earpieces wherein each of the earpieces include memory to store audio content and/or data thereon. Each earpiece includes a timing device where the two earpieces are configured to asynchronously provide audio playback of audio data stored in the memory upon or after synchronization and at a rate determined by the timing device to provide an acceptably matched audio content.

In a third exemplary embodiment, the present disclosure relates to an article comprising a storage medium having stored thereon instructions that when executed by a machine result in the following operations: providing playback of audio information on at least two earpieces wherein each of the earpieces include memory configured to store audio content and/or data thereon and a timing device. The two earpieces are configured to asynchronously provide audio playback of said audio data stored in said memory upon or after synchronization and at a rate determined by said timing device to provide an acceptably matched audio content.

### BRIEF DESCRIPTION OF DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates an exemplary embodiment of an in-ear wireless digital audio player;

FIG. 2 illustrates an exemplary schematic of the contents of an earpiece;

FIG. 3 illustrates a schematic of synchronization between the earpieces of an in-ear wireless digital audio player;

FIG. 4 illustrates an example of a flow diagram for a synchronization schedule; and

FIG. 5 illustrates an exemplary embodiment of a base station for an in-ear wireless digital audio player.

FIG. 6 illustrates an exemplary timing identifying one protocol for skipping a portion of audio data as may be desired by a user.

### DETAILED DESCRIPTION

The present invention relates to providing an in-ear wireless digital audio player. The in-ear/on-ear wireless digital audio player may include two earpieces each having a synchronizable digital audio player that fit and anchor to or within a user's ears, which, together, play stereo music. It should be appreciated that while the specification herein refers to the use of two or a pair of players, more than two players may be utilized. The audio players are capable of playing in unison or simultaneously, or in a manner (as explained more fully below) where the playback of audio content (e.g. stereo) between two or more earpieces is sufficiently matched to provide an acceptable playback experience. The units may therefore each contain an independent timing mechanism. When the units are brought back together (e.g. into electrical contact) and/or configured to respond to a given command, the internal timing device may be synchronized.

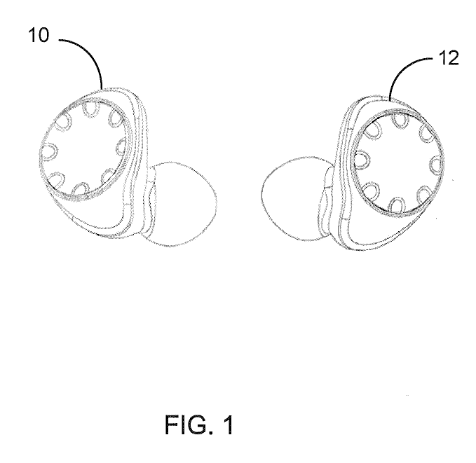

As illustrated in FIG. 1, a digital audio player and speaker may be integrated into a single earpiece housing 10 and 12. A separate digital audio player may not be necessary to drive the speakers and, therefore, cords for connecting the earpieces to a separate digital audio player may not be necessary. Furthermore, the in-ear wireless digital audio player may include two players or earpieces 10 and 12 which may be independent of each other but may play a list of songs or other audio content together, asynchronously, each delivering respective right and left channels. The ear pieces may also be relatively low power, having a total operating power of 2 W or less, but preferably, less than 60 mW. In addition, the ear piece may include relatively low power transceivers, for sending and receiving a relatively low power synchronization and/or control signal. Such relatively low power transceivers may be as much as 100 mW or more but may operate only briefly when synchronization or control signals are being sent or received, communicating with the other transceiver on a predetermined schedule that results in a lower overall duty cycle and reduce power consumption.

The earpieces may be retained by a user's ears. For example, the earpiece may be held or retained in the user's ear by the tragus or a projection of skin or cartilage in front of the meatus of the external ear and/or held against the concha. In addition, the earpiece may be retained such that the speaker or electromechanical transducer is in communication with the ear canal to provide auditory stimulation to the ear. The device may also anchor to the ear by going around/behind the ear and containing an acoustic transducer that sits near or in the ear canal.

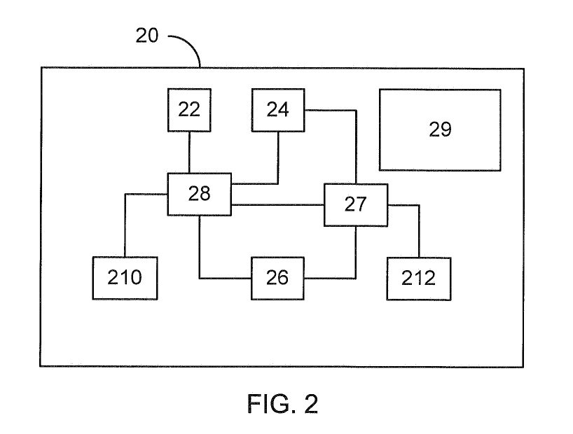

As illustrated in FIG. 2, each digital audio player earpiece 20 may include an electro-mechanical transducer, such as a speaker, 22, memory, such as flash memory, 24, a timing device 26, an audio processor 28, a controller 27 and an energy storage device, such as a battery 29. The flash memory may include audio content (e.g. music) and audio data (e.g., information about the music, such as song length, composer, etc.). A timing device may include a timing reference, such as an oscillator, and a resettable counter, either of which may be adjusted to accommodate differences between said timing device and other timing devices. The audio processor may be in electrical communication with the memory device and receive audio data from the memory device for audio playback. The processor and thus audio playback may be governed by the timing device also provided in communication with the audio processor. In addition, the energy storage device may provide power to drive the player electronics which may include the audio processor, the electro-mechanical transducer and the timing device.

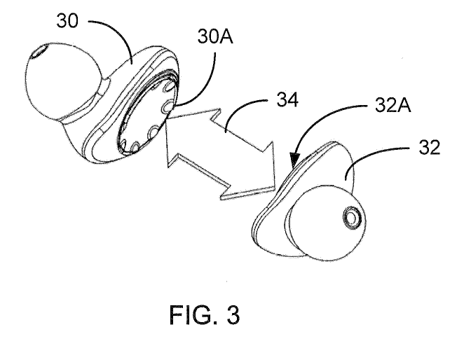

In a first example, and to synchronize the earpieces/audio players, the players 30 and 32 may communicate 34 with one another as illustrated in FIG. 3. Although this may be accomplished through IR or wireless communication, such as relatively low power radio frequency, between the players 30 and 32, the players 30 and 32 may be physically and electrically connected together directly or indirectly through an intermediate device. The physical connection may be promoted by the use of magnets or mechanical connections. That is, the opposing surface of the players 30A and 32A may be magnetized such that they may join together and/or be in electrical communication when not in use.

The players may also be connected using a cable with a connector for each player, a base station in which the earpieces may communicate or by touching two players together. Once separated, the timing devices within the players may begin counting and playing the audio data. The time at which the audio data begins playback may be referred to as a start time. The start time may be immediate or delayed by a set amount of time or number of counts after removal from the base station or being disconnected from each other or a communication cable.

In the former scenario, when disconnected from a base station or each other, the earpieces may begin to play audio data in a way that appears synchronized to a user, but may be asynchronous or independent from an electronics standpoint. That is, each player may operate independently or asynchronously of one another, while counting at a given rate from a common starting point, such as when the earpieces are separated from either the base station or each other disconnected from another device. Thus, independent or asynchronous playback may be understood as playback provided by each earpiece, wherein the earpieces do not communicate audio data or exchange audio content between the earpieces, base station or other auxiliary device, but rather source the audio data from the memory and processors, etc. contained within the individual earpieces. While playing, the asynchronous playback may therefore occur at a rate determined by the timing devices to provide, as discussed below, an acceptable level of matched audio content.

The players may continuously independently play songs, or other stored audio content, in the order determined when connected together or to a base station and/or an external device and may continue to play in that order until such time that they are turned off or again electrically connected together. Each player may play, for example, one channel depending on what ear it is in, i.e., the player inserted in the right ear may deliver the right channel and the player inserted in the left ear may deliver the left channel. Alternatively, the players may play in mono mode, where the right and left channels share the same content, or where only one player is desired during playback, as noted above.

Although the left and right channels, i.e., each earpiece, may appear to remain synchronized together, and acceptably matched, some level of lag or mismatch between the two may exist or develop while in use, but may not be detectable from a listener's or user's standpoint. As might be appreciated, the individual timing devices may exhibit slightly different timing rates, wherein a time count for one player is slightly longer or shorter than a time count for another associated player. The controllers in each player may periodically compare the clock speed (or resonance of each crystal contained therein, for example) when the units are connected or otherwise synchronized and software adjustments may be made to keep the players playing in relative “unison” when apart and playing independently.

For example, a small degree of lag time (mismatch) may be present as between the timing devices in each earpiece wherein the lag time may accumulate through the passage of time. Lag time amounts of plus or minus 15 milliseconds (ms), meaning that one earpiece is ahead or behind the other, or less, including all increments and values in the range of 0 ms to 15 ms, may be present between the individual earpieces over the course of playback. Lag time between plus or minus 15 ms to plus or minus 50 ms may be acceptable or unacceptable, depending on the listener or content. However, lag time of greater than plus or minus 50 ms or more may not be acceptable to most users. Accordingly, acceptable matched audio content herein may be understood as less than or equal to plus or minus 50 ms between the two timing devices. Furthermore, as lag time between the players may increase due to their asynchronous operation, the listener may sense such lag time and decide to remove the earpieces and contact the earpieces together so that the earpieces may synchronize together again. Or, as noted herein, synchronization may be accomplished by having the units respond to a given wireless command, where the communication of said command expends a relatively small amount of energy (e.g. less than or equal 100 micro Joules).

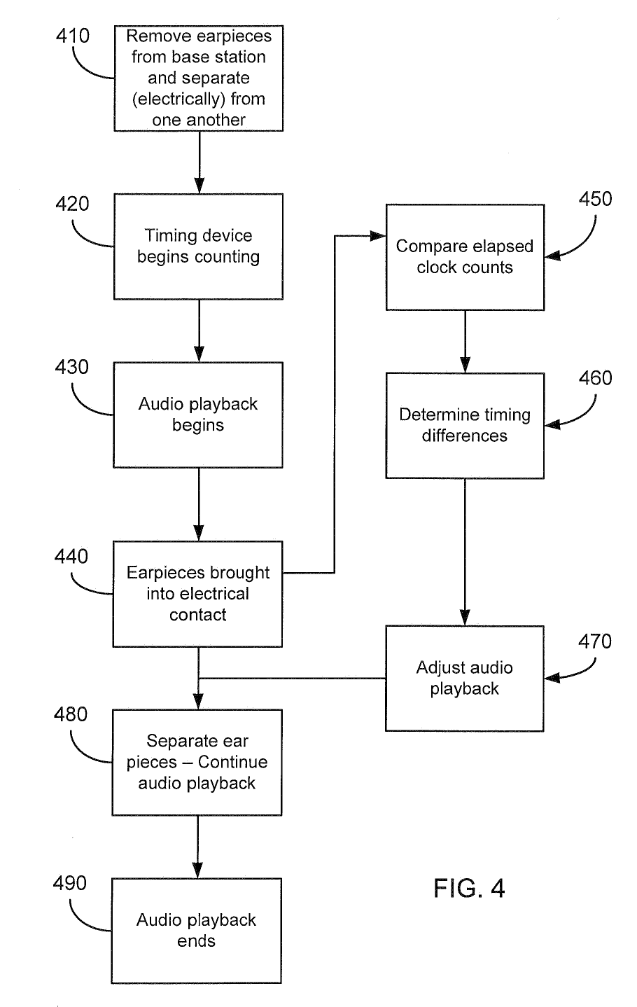

Synchronization, in this context, may be understood as the process of adjusting a timing device based upon information from one or more other timing devices to provide an acceptably matched audio content. FIG. 4 illustrates an example of how synchronization may occur. For example, upon separating the earpieces either from each other or from a base station 410, the circuitry or electronic components in the earpieces may begin counting time 420 at a rate based upon information received from the timing devices. After a given time count, or upon removal from the base station 430, or upon separating the earpieces the audio playback may begin. After a given amount of time, the earpieces may be synchronized by, for example, bringing the earpieces back into contact 440 or by other synchronization methods described below. To synchronize, the elapsed clock counts may be compared and/or the clock counts over a given time period may be compared 450. The differences between the clock counts of each timing device may then be determined 460 and the audio playback may then be adjusted 470 according to the determined differences in clock speed. The earpieces may then be separated again 480 and audio playback may end 490 upon completion of playback or returning the earpieces into the base station.

It may be appreciated that synchronization may occur during playback (when the devices are brought back in communication with one another), or synchronization may occur prior to playback while the earpieces are connected directly or indirectly together through a base station. For example, synchronization may occur when the earpieces are placed into the base station, or when the base station is in communication with an external device (described below). At any given time, the clock speeds of the timing devices may be determined and compared to adjust audio playback.

For downloading songs the players may be connected to external devices such as computers, other digital audio players, personal digital assistants (PDAs) or any other digital storage device. Once connected, songs may be downloaded to both players. From these external devices, other control may also be applied such as volume preset, shuffle mode, tempo, and start time (i.e., the amount of delay desired before the units begin playing).

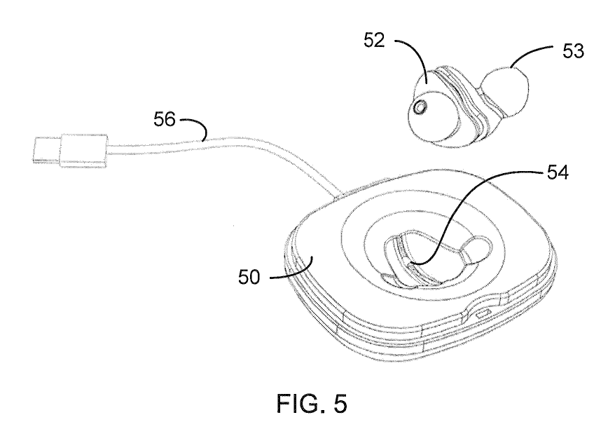

An additional component to the in-ear wireless digital audio player system is a base station, as illustrated in FIG. 5. The base station 50 may hold and protect the players 52 and 53 while not in use. The players 52 and 53 may electrically contact the base station via electrical contacts within the base station 54 and on the earpieces (not illustrated) allowing the base station to be a conduit (wired or wireless) to the external devices mentioned above. The base station may also employ other means to download data, including wireless, IR, etc. Accordingly, the base station may include a communication interface 56 between the base station and an external device. However, it should be appreciated that the players may be enabled to communicate directly with the external devices mentioned above, as well. The base station may also include a slot for inserting memory cards for direct download to the players.

The base station may also charge the battery in the individual players. For this, external power supplies may be connected to the base station. The base station itself may also carry a battery inside for an alternative charging method to the players and powering of the base station electronics. The base station battery may be capable of charging the players several times with its own batteries or power source. Charging of the players from the base station battery(s) may be an added convenience if external power sources are not readily available. The base station itself may also be powered through traditional house power, i.e., a wall outlet, or through a USB or other cable that connects to a host device.

The base station may also include provisions for configuring the players. Setting the start time of the players, and triggering their counting protocols, for example, may be achieved via the base station. In addition, setting volume or other user preferences may be done there as well.

In another example, where the base station may act as an intermediate device, which may in turn be connected to another host device (e.g., a laptop), the external host device may be utilized to configure the players. The external device may provide an interface for setting the start time of the players, triggering counting protocols, pre-setting or adjusting volume controls, etc. Finally, a simple electrical cable may be used to connect the two players to each other and to another host device.

In another embodiment, a base station may be similar to an alarm clock, but with an interface for programming the players when it is docked. A user can set a wakeup time and music or other audio content to be played, and then remove the players from the base station and place it in his or her ear. The players may then begin an internal clock such that it begins playing music at the right time to wake a user without waking someone else in the bed. The alarm clock base station may have a his and her earpiece (player) or include more than one pair of earpieces, as necessary.

Controlling the players while in the ear may be facilitated by switches or sensors located on the exterior face of the individual players. One option for control is a single switch that extends to the entire exterior face of a player. In another embodiment, a capacitance sensor may be provided. Tapping of the exterior face of player once or a sequence of taps can represent different functions. For example, one tap may increment the volume. Another single tap may induce a second volume up while a third tap may lower the volume back down to its original position. A double tap may induce a different command such as mute. It may be appreciated that any number of command/tap sequences may be provided, wherein rather than for example using one tap for incrementing volume, placing the finger over the switch and/or sensor for an elongated period of time may increase the volume. Alternatively discrete switches may be applied to the exterior face for each function. Another possibility is to use the current generated in the speaker coil as a result of the perturbation created by a user tapping the player. Effectively, the speaker may become a user switch/sensor.

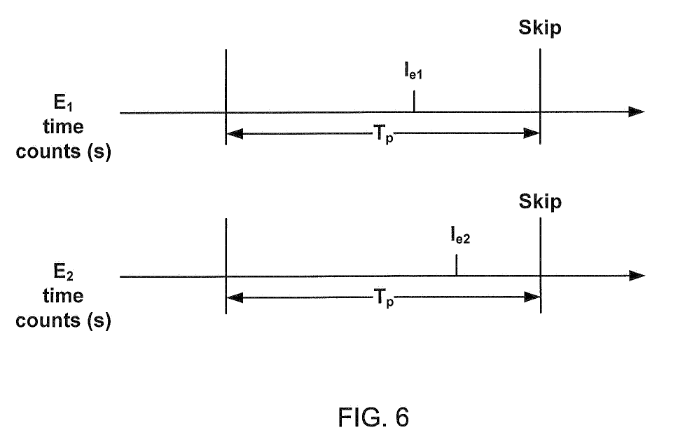

Skipping a portion of the audio data, in a given play list may be accomplished with the otherwise independent earpieces, while maintaining synchronization. For example, as illustrated in the timing diagram of FIG. 6, within a predetermined time period T_{P}, each earpiece (E₁ and E₂) will allow for input to advance the audio a given amount. For example, each earpiece will allow, within a multiple of preselected time periods (for example multiple 10 second periods), an instruction to move forward in the audio file a selected amount. Accordingly, as the user enters the instruction (Iₑ₁) in one earpiece to move forward in the audio playback to a next song, the earpiece waits until the end of the given time period (e.g., 10 seconds) to implement this instruction. The user then would naturally enter the same instruction to the second earpiece (Iₑ₂), and do so within the available selected window (again, e.g. a 10 second window). Accordingly, when the units reach the end of the exemplary 10 second window, the units move forward (Skip) to the next song or by a given segment of time as instructed, and do so in a synchronized manner. Of course, if the user enters a command to move forward to the next song in the audio playback in a first earpiece, and then fails to instruct the second earpiece to move forward within the selected window (again, e.g. 10 seconds), the units may then become unsynchronized. However, the user will immediately recognize this issue, and will need to synchronize the earpieces by connecting them together or by the other mechanisms described herein.

In another embodiment, another approach may be to give the user a limited amount of time at the start of each audio file or song to press the skip button. If a player receives the command within that time then the player may wait until the end of the time limit and then skip forward the length of the song minus the increment of time allowed for skipping at the beginning of the song. For example, at the beginning of a song, a user may have ten seconds to hit the skip button. One player may receive the skip command 2 seconds after the song starts and the other 4 seconds after the song starts. Each player may then wait for the given amount of time in the song or audio playback, for example, 10 seconds to elapse. Since the players received the skip command with in the first ten seconds then it skips forward the length of the song minus 10 seconds. Since both players know the length of the song then both player may move forward in time the same exact amount of time keeping them in sync. The drawback may come when only one player receives the skip command within the time limit. The players may become out of sync and may need to be removed and synchronized again.

With the additional component of a microphone, voice control may be achieved for the players. Referring back to FIG. 2, the microphone 210 may be provided in communication with the audio processor. Simple commands such as “louder,” “softer,” “skip” and “mute”, may be achieved without attempting to find a switch on the players. Because people don't want to listen to music in situations where they might be at risk (for example, when jogging or riding in a high traffic area), having a mute function may be relatively important. However, as long as the earpiece is in the ear, ambient sound may be muffled. In one embodiment, the same microphone that picks up voice commands may temporarily pipe through ambient noise to the user while in “mute mode” so that the user may properly assess a traffic situation or other situations. Upon releasing the mute command to play music again, the songs remain together, as their clocks continued to keep time during the mute session.

In another example, the microphone may be utilized to detect “inaudible” audio signals provided by one earpiece to another earpiece. The “inaudible” audio signals may be, for example, extremely high pitched signals provided at a frequency outside of the range detectable by the human ear. A user may adjust a control in one earpiece and such adjustment may then be communicated to the other earpiece by providing the inaudible audio signal through the electro-mechanical acoustical device.

A similar voice activated scenario may also be contemplated for a more traditional wired headset. In one embodiment, a left and right wired earpiece speaker would come together into a small module that may contain a small microphone and some processing capability. This unit could also be configured to be a separate dongle connected to an MP3 interface connector, for example an IPOD. Upon entering “mute mode,” the microphone may pump ambient audio into the speakers and then resume music after the mute mode is over. The module may also interpret other commands. Power may be drawn from a small (potentially rechargeable) battery or from a host device, like an MP3 player. In the case of a wired speaker and an MP3 or other player, user commands to the voice control module could also select songs or play lists without having to fiddle with the host MP3 unit.

In addition, while maintaining independence during audio playback, the earpieces may be provided with a relatively low power and/or low duty transceiver 212. The transceiver 212 may allow for signals to be sent and received by the earpieces for periodic synchronization and relay of control functions, e.g., mute, volume, etc. Accordingly, a user may activate a control switch or sensor in one earpiece, which may then provide the other earpiece with a correlating command. In addition, synchronization commands may be provided via the transceivers, wherein one earpiece sends signals to provide information, such as clock speed, to allow for the audio processors to adjust the audio data playback.

In a further embodiment, independent control modules may be utilized to provide control or synchronization functions to the earpieces. For example, a watch or wristlet, pendant, arm band or other device may include controls, i.e., switches or sensors for receiving commands from a user. The commands may be sent to the individual earpieces via transceivers within the earpieces, which may then receive the control information. The independent control module may also provide a synchronization signal to the earpieces, wherein the earpieces may provide feedback to the independent control module as to, for example clock speeds. The independent control module may, in turn, provide information regarding synchronization back to the earpieces.

The independent control module may also include other functionality. The functionality may include biometric feedback and/or audio information. Thus, a user's pulse, temperature, heart rate, etc., may be measured and an indication of such readings may be provided to the user through the earpieces. The earpieces may provide a voice over the audio playback or may mute or pause the audio playback to provide the data to the user. In addition, the independent control module may provide other information to the user such as distance traveled, calories burned or the amount of time remaining or passed during the course of a given period, such as the period for which the earpieces have been activated. It is also contemplated herein that the earpieces themselves may measure and store biometric feedback of the type indicated above.

Accordingly, an aspect of this disclosure relates to an audio player comprising an earpiece including a speaker, flash memory, a timing device, an audio processor and a battery. The in-ear audio player may include a pair of earpieces, wherein each earpiece delivers a channel of audio content. The in-ear audio player may also include a microphone for receiving voice commands from the user. In addition, the in-ear audio player may include at least one switch for controlling user preferences, such as volume.

Furthermore, rather than earpieces, the in-ear audio device may be provided in a headphone type configuration, wherein a small module may be incorporated and in communication with the headphones to provide voice activation functionality. The module may include a microphone, a controller, audio content, etc.

Another aspect of this disclosure relates to a base station for accommodating an in-ear/on-ear audio player, wherein the base station may electrically communicate with the earpieces and may be capable of providing power to the earpieces, providing content to the earpieces or controlling the volume or configure other user preferences. The base station may also communicate with an external device to obtain audio content for the earpieces or provide power for the base station and/or earpieces. In a further aspect, the base station may include a slot for receiving a memory device, such as a flash card. In addition, the base station may include the functions of an alarm clock, such that the base station may begin a timer within the earpiece and the earpiece may set off an alarm after the expiration of the timer.

As alluded to above, the earpieces may be relatively low power devices, with relatively low power radio-frequency communication, meaning that such devices may preferably require 60 mW of power or less. Such low power may be realized by not streaming high quality audio content (e.g. 128 kilobits/second but not less than 32 kilobits/second) from one earpiece to another, or streaming audio high quality content to and from a base device, but rather by providing independent audio playback from the individual devices.

In addition, the power usage may be maintained at a relatively low level by increasing or decreasing the activity of portions of the earpiece electronics to the extent that their function is required in a given period of time. For example, the controller may be slowed down or sped up depending on the demand for its services. Similarly, the transceiver may also be utilized such that the transceiver or components within the transceiver (such as the receiver and/or transmitter) may be only turned for a short period of time on a predetermined schedule. Once again, after the predetermined amount of time has elapsed, the transceiver may “wake up” and relay any control or synchronization signals that may have been given during the intervening period. It may be noted that synchronization of the earpieces may be programmed to coincide with the activation of the transceivers and/or other components of the earpieces.

A further aspect of this disclosure relates to a method for providing content or controlling an in-ear audio player by providing a base station, providing earpieces including a speaker, flash memory, an oscillator, an audio processor and a battery, providing communication between the base station and the earpieces, providing audio content from the base station to the ear pieces, setting user preferences and synchronizing the earpieces.

A further aspect relates to a system for providing an in-ear audio player comprising earpieces including a speaker, flash memory, an oscillator, an audio processor and a battery, and an external device capable of communicating with the earpieces. The system may also include a base station capable of communicating with the earpieces and the external device.

Another aspect relates to a method of synchronizing an in-ear audio player comprising providing communication between at least one pair of earpieces, wherein the form of communication may include wireless communication or electrical communication.

The foregoing description of several methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A device for audio playback, comprising:
at least two earpieces wherein each of said earpieces include memory configured to store audio content and/or data thereon and a timing device and said at least two earpieces are configured to asynchronously provide audio playback of said audio content stored in said memory upon or after synchronization and at a rate determined by said timing device to provide acceptably matched audio content.

2. The device of claim 1 wherein said earpieces contain electronics which comprise:
an audio processor,
an electro-mechanical transducer in communication with said audio processor,
said timing device in communication with said audio processor,
said memory in communication with said audio processor, and
a controller.

3. The device of claim 1, wherein said earpieces are configured to be electrically connected and to synchronize said timing devices therein before electrically separating said earpieces from one another.

4. The device of claim 1, wherein said earpieces are configured to synchronize said timing devices therein upon or after electrically connecting said earpieces with one another.

5. The device of claim 2, wherein said earpieces further comprise a transceiver, wherein one of said at least two earpieces is configured to send a signal and at least one of another of said at least two earpieces is configured to receive said signal.

6. The device of claim 5, wherein said earpieces are configured to synchronize said timing devices, upon sending and receiving said signal.

7. The device of claim 5, wherein said earpieces include control functions and are configured to relay inputs to said control functions between said earpieces upon sending and receiving said signal.

8. The device of claim 2, wherein said earpieces include a microphone in communication with said earpiece electronics.

9. The device of claim 8, wherein one of said at least two earpieces are configured to send an audio signal and another of said at least two earpieces is configured to receive said signal and synchronize said timing devices, or respond to a control input upon sending and receiving said signal.

10. The device of claim 8, wherein said earpiece electronics are configured to receive and process voice commands.

11. The device of claim 2, wherein said timing devices each include a timing reference and said timing devices are configured to compare said timing references and adjust said audio play back.

12. The device of claim 1, further comprising a base station, wherein said earpieces include electrical contacts for providing electrical communication with said base station.

13. The device of claim 12, wherein said base station is configured to communicate with an external device.

14. The device of claim 2, further comprising an external device configured to provide said memory with said audio content and/or data.

15. The device of claim 2, further comprising an energy storage device in each of said at least two earpieces and a base station including an energy source configured to charge said energy storage devices in said at least two earpieces.

16. The device of claim 1, wherein said earpieces are configured to be retained by the tragus.

17. The device of claim 1, wherein said earpieces are configured to extend into a portion of an ear canal and said electromechanical transducer is positioned in communication with said ear canal.

18. The device of claim 6, further comprising an independent control module configured to send control and/or synchronization signals to at least one of said at least two earpieces.

19. The device of claim 5, further comprising an independent control module configured to measure biometric data.

20. The device of claim 19, wherein said independent control module is configured to provide said biometric data to said earpieces and said earpieces provide an indication of said biometric data.

21. The device of claim 20, wherein said indication is provided by a voice over said audio playback.

22. The device of claim 5 wherein said transceivers are configured to communicate on a predetermined schedule.

23. The device of claim 18 wherein said transceivers are configured to communicate on a predetermined schedule.

24. The device of claim 1 wherein said timing devices are within plus or minus 0 to 15 milliseconds of one another.

25. The device of claim 8 wherein said microphone can deliver ambient sound through at least one of said earpieces.

26. The device of claim 1 wherein at least one of said earpieces measures and stores biometric data.

27. The device of claim 26 wherein said biometric data is provided by a voice over said audio playback.

28. A method of providing audio playback comprising:
providing at least two earpieces wherein each of said earpieces include memory to store audio content and/or data thereon and a timing device where said two earpieces are configured to asynchronously provide audio playback of said audio content stored in said memory upon or after synchronization and at a rate determined by said timing device to provide acceptably matched audio content; and
playing said audio content.

29. The method of claim 27 wherein said earpieces are configured to be electrically connected and said timing devices therein are synchronized before electrically separating said earpieces from one another.

30. The method of claim 25, wherein said earpieces further comprise a transceiver, wherein one of said at least two earpieces sends a signal to another of said at least two earpieces, wherein said signal synchronizes said timing devices.

31. The method of claim 25 comprising supplying a command to one of said earpieces, wherein said earpiece skips a portion of said played audio content upon a given time count from said timing device.

32. An article comprising a storage medium having stored thereon instructions that when executed by a machine result in the following operations:
providing playback of audio information on at least two earpieces wherein each of said earpieces include memory configured to store audio content and/or data thereon and a timing device and said at least two earpieces are configured to asynchronously provide audio playback of said audio content stored in said memory upon or after synchronization and at a rate determined by said timing device to provide acceptably matched audio content.
